(19) United States
(12) Patent Application Publication
(10) Pub. No.: US 2025/0237185 A1
(43) Pub. Date: Jul. 24, 2025

(54) VEHICLE AIR INTAKE APPARATUSES AND METHODS THEREOF

(71) Applicant: DAIMLER TRUCK NORTH AMERICA, Portland, OR (US)

(72) Inventors: Adrian Jones, Portland, OR (US); Scott Watson, Portland, OR (US)

(73) Assignee: DAIMLER TRUCK NORTH AMERICA, Portland, OR (US)

(21) Appl. No.: 18/853,668

(22) PCT Filed: Apr. 4, 2023
(86) PCT No.: PCT/US2023/017494

§ 371 Date: Oct. 2, 2024

Related U.S. Application Data
(60) Provisional application No. 63/327,987, filed on Apr. 6, 2022.

(51) Int. Cl. F02M 35/10

(52) U.S. Cl. CPC F02M 35/10144; F02M 35/10137; F02M 35/10321; F02M 35/10347; F02M 35/10386

(57) ABSTRACT

This technology relates to air intake apparatuses that in some examples include a pipe including a throttle body outlet configured to be coupled to an engine throttle body and a resonator outlet configured to be coupled to a resonator of an engine intake system, an exterior surface including a pipe aperture, a sensor insert coupled to the exterior surface and including an insert aperture substantially aligned with the pipe aperture, and an inlet configured to be coupled to an engine air filter. The sensor insert is configured to be coupled to a mass air flow (MAF) sensor. The air intake apparatus can further include an air intake sleeve including a sleeve aperture and received by the pipe such that the sleeve aperture is substantially aligned with the pipe and insert apertures to facilitate extension of a portion of the MAF sensor into an air flow path, thereby improving MAF sensor output.

This application claims priority to U.S. Provisional Patent Application No. 63/327,987, filed Apr. 6, 2022, which is incorporated by reference herein in its entirety.

### FIELD

This technology generally relates to vehicle air intake apparatuses and, more particularly, to vehicle air intake apparatuses that facilitate improved mass air flow (MAF) sensor output and methods of manufacturing the same.

### BACKGROUND

Internal combustion engines include air intake systems that receive air from the external environment, filter the air to remove contaminants, and direct the filtered air toward cylinders via a throttle body and other intermediary components. A tube or pipe is generally disposed between the throttle body and the air filter. A mass air flow (MAF) sensor can be mounted to the pipe to measure the volume of air in an air flow path toward the throttle body. The MAF sensor is communicably coupled to an engine control module (ECM) that controls the amount of fuel that is injected. The amount of injected fuel is based on the volume of air in order to maintain an appropriate air-to-fuel ratio for proper engine operation and performance.

The throttle body is attached to an engine provided on rubber mounts to allow for vibratory and other movement. Thus, the pipe of the air intake system is generally made of a relatively pliable material (e.g., rubber) such that the pipe is flexible in response to throttle body movement. Due to this flexibility, the pipe can compress or otherwise deform and thereby increase or decrease the air flow velocity proximate the MAF sensor, resulting in an inaccurate MAF sensor output. With an inaccurate MAF sensor output, the ECM may provide an inappropriate air-to-fuel ratio causing the vehicle engine to misfire and/or generate on-board diagnostic (OBD) codes that may not accurately reflect an emissions or other failure.

### SUMMARY

In one example, an air intake apparatus is disclosed that includes a pipe including a throttle body outlet configured to be coupled to a vehicle engine throttle body and a resonator outlet configured to be coupled to a resonator of a vehicle engine intake system, an exterior surface comprising a pipe aperture, a sensor insert coupled to the exterior surface and including an insert aperture substantially aligned with the pipe aperture, and an inlet configured to be coupled to a vehicle engine air filter. The sensor insert is configured to be coupled to a mass air flow (MAF) sensor. The air intake apparatus in this example further includes an air intake sleeve including a sleeve aperture and received by the pipe such that the sleeve aperture is substantially aligned with the pipe and insert apertures to facilitate extension of a portion of the MAF sensor into an air flow path.

In another example an air intake sleeve is disclosed that includes an interior end opposite an exterior end. The exterior end is configured to be disposed toward an inlet of a pipe of an air intake apparatus when the air intake sleeve is received by the pipe and the inlet is configured to be coupled to a vehicle engine air filter. In this example, a sleeve aperture is disposed between the interior and exterior ends and configured to substantially align with a pipe aperture of the pipe, and an insert aperture of a sensor insert coupled to the pipe, to facilitate positioning of a portion of a MAF sensor into an air flow path within the pipe when the MAF sensor is coupled to the sensor insert and the air intake sleeve is received by the pipe. The interior end and the exterior end are each spaced about 40-60 millimeters from a midline of the sleeve aperture.

In yet another example, a method of manufacturing an air intake apparatus is disclosed that includes molding a pipe via a first material having a first stiffness. The molding in this example includes over-molding a sensor insert at an exterior surface of the pipe such that an insert aperture of the sensor insert substantially aligns with a pipe aperture of the pipe. A first air intake sleeve is then inserted into the pipe via an inlet of the pipe such that a sleeve aperture of the first air intake sleeve substantially aligns with the insert aperture and the pipe aperture. The first air intake sleeve includes a second material having a second stiffness greater than the first stiffness. At least the pipe is cured after the insertion of the first air intake sleeve to thereby retain the sensor insert and the first air intake sleeve in place.

The vehicle air intake apparatuses described and illustrated by way of the examples herein advantageously include an air intake sleeve disposed within a portion of the associated pipe to reduce compression or deformation of the pipe in a location proximate a MAF sensor. By increasing the stiffness of the pipe proximate the MAF sensor, the air flow across the MAF sensor is more consistent with this technology, the MAF sensor operation is improved, and the MAF sensor output is more accurate. With improved accuracy of the MAF sensor output, fewer false on-board diagnostic (OBD) codes are generated, and the air-to-fuel ratio provided to the vehicle engine, which at least partially relies on the MAF sensor output, can be improved, thereby increasing engine performance.

### BRIEF DESCRIPTION OF THE DRAWINGS

FIG. 1 illustrates an exemplary air intake apparatus;

FIG. 2 illustrates an exemplary lower pipe and an exemplary air intake sleeve of the exemplary air intake apparatus of FIG. 1 before insertion of the air intake sleeve into the lower pipe; and

FIG. 3 illustrates the exemplary lower pipe and the exemplary air intake sleeve of FIG. 2 after insertion of the air intake sleeve into the lower pipe.

### DETAILED DESCRIPTION

The air intake apparatus described and illustrated by way of the examples herein includes an air intake sleeve disposed within a lower portion of an associated pipe of the air intake apparatus and proximate a mass air flow meter (MAF) sensor to provide increased rigidity and reduce deformation or compression of the pipe. By reducing the deformation or compression of the pipe, the air flow within the pipe and across a portion of the MAF sensor that extends through the air intake sleeve and into the pipe is more consistent, which provides a more accurate and reliable output of the MAF sensor. Accordingly, with the technology disclosed herein, fewer false on-board diagnostic (OBD) codes are generated and the air-to-fuel ratio is more accurate, which yields improved engine performance.

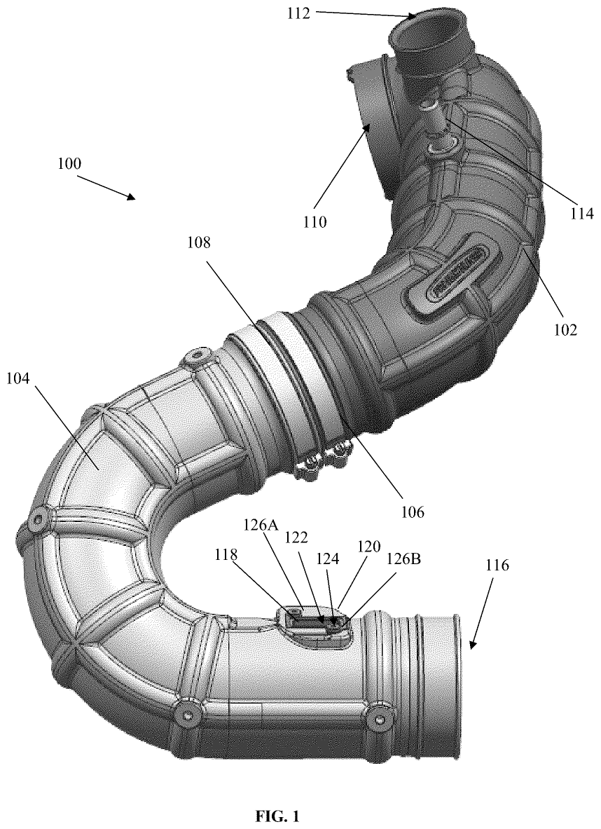

Referring to FIG. 1, an exemplary air intake apparatus 100 according to some examples of this technology is illustrated. The air intake apparatus 100 in this example includes an upper pipe 102 coupled to a lower pipe 104 via an upper clamp 106 and a lower clamp 108. In other examples, a single clamp or more than two clamps may be used. In yet other examples, the upper and lower pipes can be formed as a unitary structure, and other configurations can also be used. In some examples, the upper pipe 102 and/or lower pipe 104 can have a thickness of 3-7 millimeters, preferably 4-6 millimeters, and, in some examples, about 5 millimeters.

In this example, the upper pipe includes a throttle body outlet 110 configured to be coupled to a vehicle engine throttle body (not shown), a resonator outlet 112 configured to be coupled to a resonator of a vehicle engine intake system (not shown), and a positive crankcase ventilation (PCV) one-way valve 114 configured to be coupled to a vehicle engine crankcase (not shown). Various vehicle engine components may move during engine operation, including the throttle body that may be mounted via a flexible material (e.g., rubber or plastic) to allow for vibratory and other movement. Accordingly, one or more of the upper pipe 102 and/or lower pipe 104 can be made of rubber or other pliable material in some examples so as to be capable of absorbing and/or responding to movement introduced by the throttle body and/or other vehicle engine components to which the upper pipe 102 and/or lower pipe 104 are coupled. In one particular example, the upper pipe 102 and/or lower pipe 104 is made of ethylene propylene diene monomer (EPDM) rubber 70 durometer. In another example in which separate upper and lower pipes are not used, but instead a single unitary structure (i.e., a single pipe) is used, the single pipe can be rubber (e.g., EPDM), plastic, or any other flexible material.

The lower pipe in this example includes an inlet 116 configured to be coupled to a vehicle engine air filter (not shown). Accordingly, air from the environment may enter the air filter to facilitate removal of contaminants and continue on a flow path through the inlet 116, lower pipe 104, upper pipe 102, and out of the air intake apparatus 100 (e.g., via the throttle body outlet 110) to other engine components. In this example, a sensor insert 118 is embedded in an exterior surface of the lower pipe 104 via an over-molding 120 of rubber that retains the sensor insert 118 in place when cured, although other methods for attaching the sensor insert 118 including via adhesives and/or fasteners, for example, can also be used. In some examples, the sensor insert 118 is made of a relatively rigid material (e.g., steel or other metal).

The sensor insert 118 includes an insert aperture 122 that is substantially aligned with a pipe aperture 124 in the lower pipe 104. The sensor insert 118 also includes threaded apertures 126A-B configured to receive threaded fasteners (not shown) of a mass air flow (MAF) sensor (not shown) and thereby couple the MAF sensor to the sensor insert 118, although the MAF sensor can be coupled to the sensor insert 118 in other ways in other examples.

A portion of the MAF sensor (not shown) extends into the air flow path within the lower pipe 104 when the MAF sensor is coupled to the sensor insert 118. The MAF sensor is configured to measure the volume or mass of air in the air flow path within the lower pipe 104 and report the same to an engine control module (ECM) that controls the amount of injected fuel based on the output of the MAF sensor in order to maintain a desired air-to-fuel ratio within the vehicle engine.

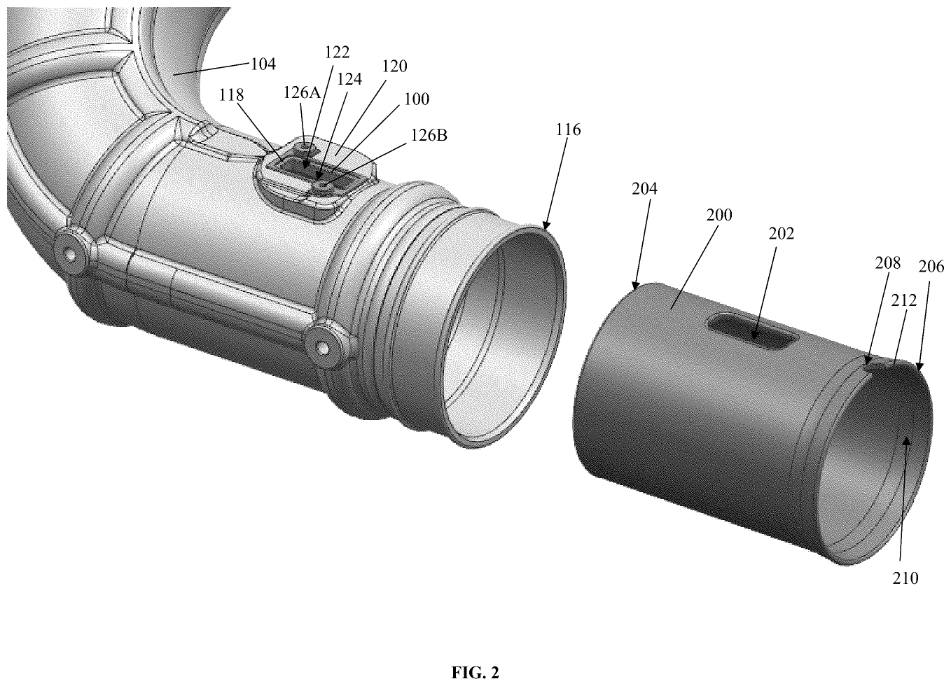

Referring to FIG. 2, an exemplary lower pipe 104 and air intake sleeve 200 of the air intake apparatus 100 are illustrated prior to insertion of the air intake sleeve 200 into the lower pipe 104. The air intake sleeve 200 is introduced to the lower pipe 104 via the inlet 116 in this example. In some examples, the air intake sleeve 200 can have a thickness of 1-5 millimeters, preferably 2-4 millimeters, and, in some examples, about 3 millimeters.

The air intake sleeve 200 has a sleeve aperture 202 that aligns with the pipe aperture 124 of the lower pipe 104 and the insert aperture 122 of the sensor insert 118 when the air intake sleeve 200 is received by the lower pipe 104. The sleeve aperture 202 is disposed between an interior end 204 and an exterior end 206 of the air intake sleeve 200 and is configured to substantially align with the pipe aperture 124 and the insert aperture 122 to facilitate positioning of a portion of the MAF sensor through those apertures and into the air flow path within the lower pipe 104 when the MAF sensor is coupled to the sensor insert 118 and the air intake sleeve 200 is received by the lower pipe 104. In some examples, the interior end 204 and the exterior end 206 are each spaced about 40-60 millimeters from a midline of the sleeve aperture 202, preferably 45-55 millimeters from the midline of the sleeve aperture 202, and, in some examples, about 49 millimeters from a midline of the sleeve aperture 202. In other examples, the interior end 204 and the exterior end 206 are each spaced about 40-60 millimeters from respective ends of the sleeve aperture 202, preferably 45-55 millimeters from the respective ends of the sleeve aperture 202, and, in some examples, about 49 millimeters from the respective ends of the sleeve aperture 202.

The air intake sleeve in this example also includes a slot 208 disposed at the exterior end 206 and substantially aligned in a longitudinal direction with the sleeve aperture 202. The slot 208 facilitates proper alignment of the sleeve aperture 202 with the insert aperture 122 and the pipe aperture 124 as the air intake sleeve 200 is inserted into the lower pipe 104. The proper alignment can be facilitated by the slot 208 based on a visual observation and/or, in another example, a separate placement tool (not shown) that is configured to engage with the slot 208 to automatically insert the air intake sleeve 200 into the lower pipe 104 at the proper orientation. In this example, the lower pipe 104 can be placed in a fixture at a known orientation to facilitate the automated insertion of the air intake sleeve 200. Other methods for inserting the air intake sleeve 200 into the lower pipe 104 can also be used in other examples.

In this particular example, the exterior end 206, which is disposed further toward the inlet 116 than the interior end 204 when the air intake sleeve 200 is received by the lower pipe 104, includes a flared portion 210 and a curved or rounded rim 212. The flared portion 210 in some examples mates or interfaces with another flared portion of the lower pipe 104 to restrict further insertion of the air intake sleeve 200 into the lower pipe 104. Accordingly, at the curved rim 212, the diameter of the air intake sleeve 200 is larger than another diameter of a remainder of the air intake sleeve 200 disposed between the flared portion 210 and the interior end 204. In operation, the combination of the flared portion 210 and the curved rim 212 reduces turbulence of the incoming air within the air flow path from the air filter into the air intake sleeve 200 and improves the consistency of the subsequent air flow in the air flow path across the MAF sensor.

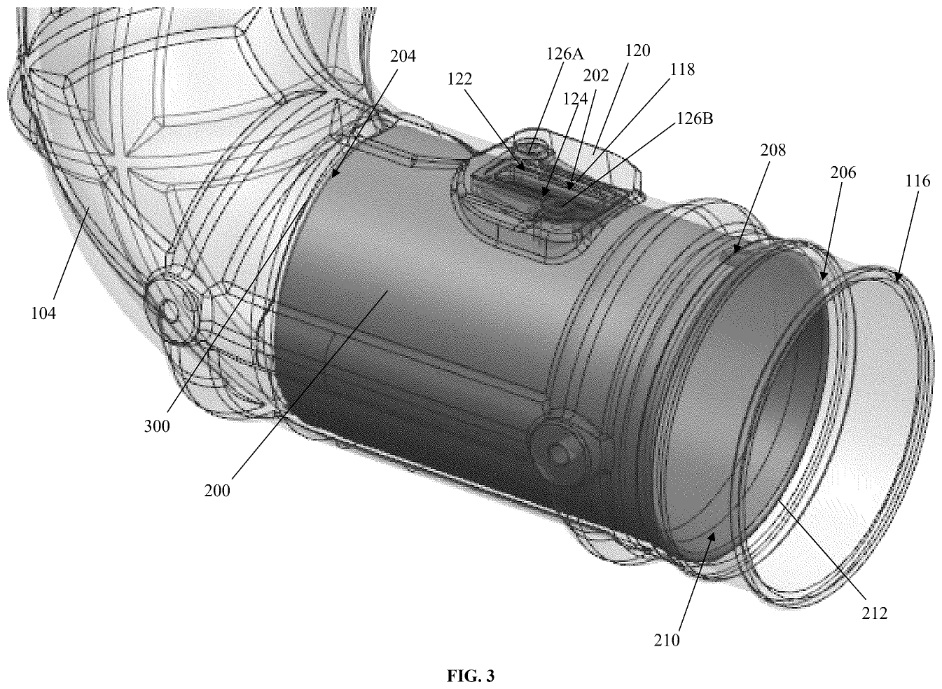

Referring to FIG. 3, an exemplary lower pipe 104 and air intake sleeve 200 of the air intake apparatus 100 are illustrated subsequent to insertion of the air intake sleeve 200 into the lower pipe 104. In this example, the lower pipe 104 includes a ridge 300 on an interior surface that is configured to be disposed adjacent to, or in contact with, at least a portion of the circumference of the interior end 204 of the air intake sleeve 200 so as to prevent further insertion of the air intake sleeve 200 into the lower pipe 104 in the longitudinal direction of the lower pipe 104 and thereby facilitate alignment of the sleeve aperture 202 with the insert aperture 122 and pipe aperture 124 in that direction. Other methods of facilitating alignment in the longitudinal direction of the lower pipe 104 can also be used in other examples.

In this example, the air intake sleeve 200 is made of a material having a greater stiffness than the material by which the lower pipe 104 is made. For example, the lower pipe 104 can be made of rubber (e.g., ethylene propylene diene monomer (EPDM) rubber) and the air intake sleeve 200 can be made of plastic, although other materials, including any flexible rubber or plastic with one or more same or substantially similar material properties (e.g., similar Young's modulus, curing time, etc.) to EPDM or 20% talc filled polypropylene for the lower pipe 104 and/or air intake sleeve 200, respectively, can also be used in other examples. In one particular example, the air intake sleeve 200 is made via injection molding and is 20% talc filled polypropylene, although the air intake sleeve 200 can also be made of steel, and other materials, as mentioned above. Additionally, the air intake sleeve 200 is designed and sized so as to be inserted into the lower pipe 104 via an interference fit, which as used herein is fit that requires some degree of force to join the two components (i.e., the lower pipe 104 and the air intake sleeve 200).

In some examples, the air intake sleeve 200 is inserted into the lower pipe 104 before the material of the lower pipe 104 is fully cured such that, when cured and hardened, in combination with the interference fit, no air in the air flow path escapes around the curved rim 212 and/or between the air intake sleeve 200 and the lower pipe 104. In some examples, at least the lower pipe 104 (and optionally the upper pipe 102) can have a Young's modulus of 2-10 MPa, more preferably 3-9, more preferably 4-8, more preferably 5-7, and in some examples about 6 MPa, and the intake sleeve 200 can have a Young's modulus of 16-48 MPa, more preferably 20-44, more preferably 24-40, more preferably 28-36, and in some examples about 32 MPa, although other stiffnesses can also be used in other examples. By utilizing the air intake sleeve 200 that has greater stiffness than the lower pipe 104, and extends in both directions away from the MAF sensor, compression and/or deformity of the lower pipe 104 proximate the MAF sensor is significantly reduced or avoided altogether, the air in the air flow path across the MAF sensor is more consistent, and the output of the MAF sensor is more accurate and reliable as compared to a lower pipe 104 comprised of the same material lacking the intake sleeve 200.

In some examples, the air intake apparatus 100 can be manufactured by first molding an air intake pipe, which as used herein includes the lower pipe 104 and the upper pipe 102 as a unitary structure, via a moldable material (e.g., rubber), such as via an injection molding process, for example. The molding includes over-molding the sensor insert 118 at an exterior surface of the air intake pipe such that the insert aperture 122 of the sensor insert 118 substantially aligns with the pipe aperture 124 of the air intake pipe.

Prior to curing, the air intake sleeve 200 is inserted into the air intake pipe via the inlet 116 such that the sleeve aperture 202 of the air intake sleeve 200 substantially aligns with the insert aperture 122 and pipe aperture 124. The slot 208 can be used for automated insertion and/or to facilitate proper rotational alignment of the air intake sleeve 200. Specifically, a tool can engage the slot 208 as the air intake sleeve 200 is inserted by the tool into the lower pipe 104 to ensure proper rotational alignment of the air intake sleeve 200 and, in particular, the insert aperture 122 and pipe aperture 124. As explained above, the air intake sleeve 200 includes a material (e.g., plastic) having a greater stiffness than material (e.g., rubber) of the air intake pipe.

Subsequent to the insertion of the air intake sleeve 200, the air intake pipe is cured, such as via a vulcanization process, to thereby retain the sensor insert 118 and the air intake sleeve 200 in place. The MAF sensor is then coupled to the sensor insert 118, such as via the threaded apertures 126A-B and threaded fasteners and such that the MAF sensor is disposed within the air flow path within the air intake pipe. To install the air intake apparatus 100, the MAF sensor can be communicably coupled to an ECM of a vehicle engine, the throttle body outlet 110 can be coupled to an inlet of a throttle body of the vehicle engine, the resonator outlet 112 can be coupled to an inlet of a resonator of the vehicle engine, the PCV one-way valve 114 can be coupled to a crankcase of the vehicle engine, and/or the inlet 116 of the air intake pipe can be coupled to an outlet of an air filter of the vehicle engine. Other methods for manufacturing and/or installing the air intake apparatus 100 can also be used in other examples.

With the technology disclosed herein, compression or deformation of the lower pipe 104 is reduced as a result of the increased rigidity proximate the MAF sensor that is provided by the air intake sleeve 200. Accordingly, air flow in the lower pipe 104 of the air intake apparatus 100 is more consistent resulting in improved MAF sensor operation, reduced generation of inaccurate OBD codes, increased accuracy of air-to-fuel ratios provided to the vehicle engine and associated increased engine performance.

Having thus described the basic concept of the invention, it will be rather apparent to those skilled in the art that the foregoing detailed disclosure is intended to be presented by way of example only and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. An air intake apparatus, comprising:
a pipe comprising a throttle body outlet configured to be coupled to a vehicle engine throttle body, a resonator outlet configured to be coupled to a resonator of a vehicle engine intake system, an exterior surface comprising a pipe aperture, a sensor insert coupled to the exterior surface and comprising an insert aperture substantially aligned with the pipe aperture, and an inlet configured to be coupled to a vehicle engine air filter, wherein the sensor insert is configured to be coupled to a mass air flow meter (MAF) sensor; and
an air intake sleeve comprising a sleeve aperture and received by the pipe such that the sleeve aperture is substantially aligned with the pipe and insert apertures to facilitate extension of a portion of the MAF sensor into an air flow path.

2. The air intake apparatus of claim 1, wherein the pipe comprises a first material comprising a first stiffness and the air intake sleeve comprises a second material comprising a second stiffness.

3. The air intake apparatus of claim 2, wherein the first stiffness comprises a Young's modulus of between 16 and 48 megapascal (MPa) and the second stiffness comprises a Young's modulus of between 2 and 10 MPa.

4. The air intake apparatus of claim 2 or 3, wherein the pipe is comprised of rubber and the air intake sleeve is comprised of plastic.

5. The air intake apparatus of any of claims 1 to 4, wherein the air intake sleeve is received by the pipe via an interference fit.

6. The air intake apparatus of claim 5, wherein the pipe comprises an upper pipe and a lower pipe coupled to the upper pipe and the air intake sleeve is received by the lower pipe via the interference fit.

7. The air intake apparatus of any of claims 1 to 6, wherein the sensor insert is coupled to the exterior surface of the pipe via an over-molding of rubber.

8. The air intake apparatus of any of claims 1 to 7, wherein the sensor insert comprises one or more threaded apertures configured to receive one or more threaded fasteners of the MAF sensor and thereby couple the MAF sensor to the sensor insert.

9. The air intake apparatus of any of claims 1 to 8, wherein the air intake sleeve further comprises a slot disposed at an exterior end of the air intake sleeve and substantially aligned in a longitudinal direction with at least a portion of each of the sleeve aperture, the pipe aperture, and the insert aperture.

10. The air intake apparatus of any of claims 1 to 9, wherein the pipe comprises an interior surface comprising a ridge configured to restrict further insertion of the air intake sleeve in a direction opposite the inlet, wherein the ridge contacts at least a portion of a circumference of an interior end of the air intake sleeve.

11. The air intake apparatus of any of claims 1 to 10, wherein the air intake sleeve comprises a flared exterior end disposed opposite an interior end and toward the inlet and comprising a substantially curved rim, wherein the sleeve aperture is disposed between the interior and flared exterior ends.

12. An air intake sleeve, comprising:
an interior end opposite an exterior end, wherein the exterior end is configured to be disposed toward an inlet of a pipe of an air intake apparatus when the air intake sleeve is received by the lower pipe, wherein the inlet is configured to be coupled to a vehicle engine air filter; and
a sleeve aperture disposed between the interior and exterior ends and configured to substantially align with a pipe aperture of the pipe, and an insert aperture of a sensor insert coupled to the pipe, to facilitate positioning of a portion of a mass air flow (MAF) sensor into an air flow path within the pipe when the MAF sensor is coupled to the sensor insert and the air intake sleeve is received by the pipe, wherein the interior end and the exterior end are each spaced about 40-60 millimeters from a midline of the sleeve aperture.

13. The air intake sleeve of any of claims 12 to 13, comprising a stiffness comprising a Young's modulus of between 2 and 10 megapascal (MPa).

14. The air intake sleeve of any of claims 12 to 13, comprising a thickness of between 1 and 5 millimeters.

15. The air intake sleeve of any of claims 12 to 14, wherein the pipe comprises a first material comprising a first stiffness and the air intake sleeve comprises a second material comprising a second stiffness that is greater than the first stiffness.

16. The air intake sleeve of claim 15, wherein the first material comprises rubber and the second material comprises plastic.

17. The air intake sleeve of any of claims 12 to 16, further comprising a slot disposed at the exterior end and substantially aligned in a longitudinal direction with the sleeve aperture.

18. The air intake sleeve of any of claims 12 to 17, wherein the exterior end is flared and comprises a substantially curved rim.

19. A method of manufacturing an air intake apparatus, the method comprising:
molding a pipe comprising a first material having a first stiffness, wherein the molding comprises over-molding a sensor insert at an exterior surface of the pipe such that an insert aperture of the sensor insert substantially aligns with a pipe aperture of the pipe;
inserting an air intake sleeve into the pipe via an inlet of the pipe such that a sleeve aperture of the first air intake sleeve substantially aligns with the insert aperture and the pipe aperture, wherein the first air intake sleeve comprises a second material having a second stiffness greater than the first stiffness; and
curing at least the pipe after the insertion of the first air intake sleeve to thereby retain the sensor insert and the first air intake sleeve in place.

20. The method of claim 19, wherein the second material has a Young's modulus of between 16 and 48 megapascal (MPa) and the first material has a Young's modulus of between 2 and 10 MPa.

21. The method of any of claims 19 to 20, wherein the pipe is comprised of rubber and the air intake sleeve is comprised of plastic.

22. The method of any of claims 19 to 21, further comprising curing at least the pipe via a vulcanization process.

22. The method of any of claims 19 to 22, further comprising coupling a mass air flow meter (MAF) sensor to the sensor insert such that a portion of the MAF sensor is disposed within an air flow path within the pipe.
